(19) United States
(12) Patent Application Publication
(10) Pub. No.: US 2018/0359556 A1
(43) Pub. Date: Dec. 13, 2018

(54) Pairing of wireless earpiece to selected device based on head movement to identify device

(71) Applicant: BRAGI GmbH, München (DE)

(72) Inventor: Gwenael Kosider, München (DE)

(73) Assignee: BRAGI GmbH, München (DE)

(21) Appl. No.: 15/975,538

(22) Filed: May 9, 2018

Related U.S. Application Data
(60) Provisional application No. 62/516,178, filed on Jun. 7, 2017.

(51) Int. Cl. H04R 1/10; G06F 3/01; H04R 1/08

(52) U.S. Cl. CPC H04R 1/1091; G06F 3/017; H04R 2201/10; H04R 2420/07; H04R 2499/11; H04R 1/08

(57) ABSTRACT

A method of connecting to an electronic device using a pair of wireless earpieces in embodiments of the present invention may have one or more of the following steps: (a) sensing a cessation of motion at an earpiece of the pair of wireless earpieces, (b) capturing an image of an area directly in front of a user in response to the cessation of motion, (c) determining whether the electronic device is present in the image, (d) transmitting a connection signal capable of being received by the electronic device if the electronic device is present in the image, (e) establishing a connection between the pair of wireless earpieces and the electronic device in response to an acceptance of the connection received at an earpiece of the pair of wireless earpieces, and (f) prompting the user whether the electronic device is present in the image.

### PRIORITY STATEMENT

This application claims priority to U.S. Provisional Patent Application No. 62/516,178 titled Pairing of Wireless Earpiece to Selected Device Based on Head Movement to Identify Device filed on Jun. 7, 2017 all of which is hereby incorporated by reference in its entirety.

### FIELD OF THE INVENTION

The illustrative embodiments relate to wearable devices. More particularly, but not exclusively, the present invention relates to wireless earpieces.

### BACKGROUND

Recent advances in technology have resulted in a proliferation of computers, electronic devices and associated accessories and peripherals adapted to link up with and communicate with each other. While many links and communications between such devices and accessories take place over wired connections, such links and communications between devices are increasingly taking place wirelessly. Examples of “host” devices for such wireless communications can include personal computers, cellular telephones, laptops, tablet computers and the like, while examples of “accessory” or peripheral devices can include headphones, wireless earpieces, keyboards, mice, printers, various other human interface (“HI”) devices and the like. The ability for such devices to communicate wirelessly presents numerous advantages and conveniences to users and consumers. Increases in the amount of wireless communications between devices in the future are inevitable.

One process ubiquitous in such wireless communications arrangements is the bonding or pairing of devices. Pairing is a process used to associate a wireless accessory or peripheral device with a wireless host device. The pairing ensures the data being transferred is not only secured but is also being transferred between appropriate devices. For example, a pairing can be used to associate a given headset or earpiece with a particular mobile phone, and vice versa. Another example can include the pairing of a wireless keyboard and wireless mouse to a computer or other host device. The pairing provides for secure data transfer between the devices, typically through use of encryption.

Although pairing can sometimes require a pin code or other identifier be entered manually by a user to pair a host device with an accessory device, many pairings between devices now use more streamlined processes, such as the Secure Simple Pairing protocol required by Bluetooth v2.1 and later devices. Such cases can involve “just works” type of devices, such as earpieces for cellular telephones or wireless mice and keyboards for computers, among others. In other circumstances, it is possible a user need not enter a pin code or take other action because a proprietary exchange of information can also facilitate pairing. In such instances, it is often sufficient for a wireless accessory device simply to enter a range of a wireless host to which it can be paired. Such streamlined processes result in a more convenient and user-friendly experience for many users and consumers.

In many such simplified cases, a wireless accessory device not paired with a host device is put into a “search” mode, whereby it actively searches for a host device with which to pair. The pairing process is then typically triggered automatically the first time the accessory device comes into range of, finds and requests to pair with a suitable host device. During the pairing process, the two devices involved establish a relationship by creating a shared secret or link key. Once a unique link key is stored by both devices, they then become paired. A device wanting to communicate only with a paired device can cryptographically authenticate the identity of the other device to be sure it is the same device with which it has previously paired. Once a link key has been generated, an authenticated link between the devices may be encrypted so the data they exchange over the airwaves is protected against eavesdropping or other unauthorized communications.

Once a pairing has been established it is remembered by the devices, which then connect to each without further user intervention. In fact, a pairing of wireless devices often remains for significant periods of time, even indefinitely. When desired, the pairing relationship can later be terminated manually by the user. In addition, the removal of one of the devices from the wireless range of the other can also facilitate the termination of a pairing relationship. In such instances, link keys can be deleted at any time by either device. If done by either device this will implicitly remove the pairing between the devices.

Unfortunately, the facilitation of pairing between wireless devices has become so streamlined the unpairing of paired devices can be troublesome in some cases. This often occurs where an accessory device is a simplified device with no display or readily understandable process for unpairing. In such instances, transferring a pairing to another host device or any other unpairing of the accessory device from its currently paired host can require separating the devices until they are out of range with each other for some time, so the simpler accessory device eventually goes into search mode again for another host device. Other inconvenient solutions to invoke a changed pairing of a wireless accessory device can include turning off one or more devices or excessive manual intervention into the unpairing and reassigning of a new pairing for the accessory device.

While many designs and techniques used to provide pairings between wireless host and accessory devices have generally worked well in the past, there is always a desire to provide improvements in such wireless systems and pairing methods. What is desired are systems and methods permitting the easy transfer of pairings from one wireless host device to another, as well as permit the ready selection of a wireless host device from multiple present and possible host devices for a wireless accessory device.

Wireless earpieces are a new category of consumer electronic device. Wireless earpieces allow the user to listen to songs, news, or other types of media without the need to be physically connected to another electronic device. Using gestures such as looking at a device or performing gestures reasonably interpreted to infer an intent to interact with another electronic device, however, have not been explored. What is thus needed are methods and systems of connecting to electronic devices using one or more wireless earpieces using certain gestures capable of being sensed by a wireless earpiece.

### SUMMARY

Therefore, it is a primary object, feature, or advantage of the present invention to improve over the state of the art.

A method of connecting to an electronic device using a pair of wireless earpieces in embodiments of the present invention may have one or more of the following steps: (a) receiving a signal from the electronic device at each earpiece of the pair of wireless earpieces, (b) sensing a cessation of motion from an earpiece of the pair of wireless earpieces, (c) connecting at least one earpiece of the pair of wireless earpieces to the electronic device in response to the cessation of motion if the signal from the electronic device originates (1) within three meters from a user, and (2) approximately within a horizontal plane between the pair of wireless earpieces, (d) recording positions of a user's head at each earpiece while receiving the signal from the electronic device at each earpiece of the pair of wireless earpieces, (e) determining an intent of the user using the positions of a head of the user determined by the pair of wireless earpieces, and (f) connecting at least one wireless earpiece of the pair of wireless earpieces to the electronic device in response to a determination of the intent of the user if the intent of the user is to interact with the electronic device and the signal from the electronic device originates (1) within three meters from the user and (2) approximately within a horizontal plane created by the positions of the head of the user at each earpiece while receiving the signal from the electronic device at each earpiece of the set of wireless earpieces, and (g) prompting the user to connect to the electronic device if the signal from the electronic device originates (1) within three of the user and (2) approximately within a horizontal plane between the pair of wireless earpieces.

A method of connecting to an electronic device using a pair of wireless earpieces in embodiments of the present invention may have one or more of the following steps: (a) sensing a cessation of motion at an earpiece of the pair of wireless earpieces, (b) capturing an image of an area directly in front of a user in response to the cessation of motion, (c) determining whether the electronic device is present in the image, (d) transmitting a connection signal capable of being received by the electronic device if the electronic device is present in the image, (e) establishing a connection between the pair of wireless earpieces and the electronic device in response to an acceptance of the connection received at an earpiece of the pair of wireless earpieces, (f) prompting the user whether the electronic device is present in the image, and (g) prompting the user whether the user wishes to establish the connection to the electronic device.

A pair of wireless earpieces, each wireless earpiece in embodiments of the present invention may have one or more of the following features: (a) an earpiece housing, (b) a processor disposed within the earpiece housing, (c) a motion sensor mounted to the earpiece housing and operatively connected to the processor of the earpiece in which the motion sensor is mounted to, (d) a transceiver disposed within the earpiece housing and operatively connected to the processor of the earpiece in which the transceiver is disposed within, wherein at least one processor is configured to determine a location of an electronic device using a signal received from the electronic device, wherein each motion sensor is configured to sense a motion of the wireless earpiece in which the motion sensor is mounted to, wherein both transceivers are configured to receive the signal from the electronic device, wherein the signal encodes a frequency in which to connect to the electronic device, (e) a camera mounted to each earpiece housing and operatively connected to the processor of the earpiece in which the camera is mounted to, wherein each camera is positioned proximate to a side of each wireless earpiece facing away from a user's ear and facing an area directly in front of the user, and (f) a microphone mounted to each earpiece housing and operatively connected to the processor of the earpiece in which the microphone is mounted to, wherein each microphone is configured to receive one or more sounds from the electronic device.

One or more of these and/or other objects, features, or advantages of the present invention will become apparent from the specification and following claims. No single embodiment need provide every object, feature, or advantage. Different embodiments may have different objects, features, or advantages. Therefore, the present invention is not to be limited to or by an object, feature, or advantage stated herein.

### BRIEF DESCRIPTION OF THE DRAWINGS

Illustrated embodiments of the disclosure are described in detail below with reference to the attached drawing figures, which are incorporated by reference herein.

FIG. 1 illustrates a block diagram of the pair of wireless earpieces in accordance with embodiments of the illustrative embodiment;

FIG. 2 illustrates a block diagram of a second embodiment of the pair of wireless earpieces in accordance with embodiments of the illustrative embodiment;

FIG. 3 illustrates the pair of wireless earpieces in accordance with embodiments of the illustrative embodiment;

FIG. 4 illustrates a right wireless earpiece and its relationship to a right year of a user in accordance with embodiments of the illustrative embodiment;

FIG. 5 illustrates the pair of wireless earpieces and their relationship to an electronic device in accordance with embodiments of the illustrative embodiment;

FIG. 6 illustrates a flowchart of a method of connecting to an electronic device using a pair of wireless earpieces in accordance with embodiments of the illustrative embodiment;

FIG. 7 illustrates a flowchart of a second embodiment of a method of connecting to an electronic device using a pair of wireless earpieces in accordance with embodiments of the illustrative embodiment.

Various of the figures include ornamental appearance for various elements. It is to be understood the present invention contemplates all permutations and combinations of the various graphical elements set forth.

### DETAILED DESCRIPTION

The following discussion is presented to enable a person skilled in the art to make and use the present teachings. Various modifications to the illustrated embodiments will be clear to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of wireless earpieces with gestural pairing control, it is fully contemplated embodiments of the present invention could be used in most any wearable electronic device without departing from the spirit of the invention.

It is an object, feature, or advantage of the present invention to connect a pair of wireless earpieces to an electronic device in response to a head gesture of a user of the pair of wireless earpieces.

It is a still further object, feature, or advantage of the present invention to connect a pair of wireless earpieces to an electronic device using a signal transmitted by the electronic device in response to a head gesture of a user of the pair of wireless earpieces.

It is a still further object, feature, or advantage of the present invention to connect a pair of wireless earpieces to an electronic device using a signal transmitted by a wireless earpiece in response to a head gesture of a user of the pair of wireless earpieces.

Another object, feature, or advantage is to connect a pair of wireless earpieces to an electronic device using a signal transmitted by the electronic device in response to a head gesture of a user of the pair of wireless earpieces, wherein the head gesture is associated with one or more sounds generated or transmitted by the electronic device.

Another object, feature, or advantage is to connect a pair of wireless earpieces to an electronic device using a signal transmitted by an earpiece in response to a head gesture of a user of the pair of wireless earpieces, wherein the head gesture is associated with one or more sounds generated or transmitted by the electronic device.

Yet another object, feature, or advantage is to associate a cessation of motion of a wireless earpiece worn by the user to a head gesture.

Yet another object, feature, or advantage is to associate a cessation of motion with a user intent to connect to an electronic device.

Yet another object, feature, or advantage is to connect a pair of wireless earpieces to an electronic device in response to a determination that the electronic device is present in an image captured by a camera operably connected to one of the earpieces, wherein the image is captured in response to a head gesture of the user.

Yet another object, feature, or advantage is to connect a pair of wireless earpieces to an electronic device in response to a determination that the electronic device is present in a video captured by a camera operably connected to one of the earpieces, wherein the video is captured in response to a head gesture of the user.

In one embodiment, a method of connecting to an electronic device using a pair of wireless earpieces includes receiving a signal from the electronic device at each earpiece of the pair of wireless earpieces, sensing a cessation of motion from an earpiece of the pair of wireless earpieces, and connecting at least one earpiece of the pair of wireless earpieces to the electronic device in response to the cessation of motion if the signal from the electronic device originates (1) within a few meters from a user and (2) approximately within a horizontal plane between the pair of wireless earpieces.

One or more of the following features may be included. The electronic device may be a mobile phone, a tablet, a laptop, or a desktop computer. The signal may be a sound wave. The signal may be received continuously. The signal may encode at least one frequency in which to communicate with the electronic device. Positions of a user's head may be recorded at each earpiece while receiving the signal from the electronic device. An intent of the user may be determined using the positions of the user's head recorded by the pair of wireless earpieces. At least one earpiece may be connected to the electronic device in response to a determination of the intent of the user if the intent of the user is to interact with the electronic device and the signal from the electronic device originates (1) within a few meters from the user and (2) approximately within a horizontal plane created by the positions of the head of the user at each earpiece while receiving the signal from the electronic device at each earpiece of the set of wireless earpieces. The user may be prompted to connect to the electronic device if the signal from the electronic device originates (1) approximately a few meters from the user and (2) approximately within a horizontal plane between the pair of wireless earpieces. In one embodiment, a few meters may represent 1-5 meters. In another embodiment, a few meters may represent 0-15 meters.

In another embodiment, a method of connecting to an electronic device using a pair of wireless earpieces includes sensing a cessation of motion at an earpiece of the pair of wireless earpieces, capturing an image of an area directly in front of a user in response to the cessation of motion, determining whether the electronic device is present in the image, transmitting a connection signal capable of being received by the electronic device if the electronic device is present in the image, and establishing a connection between the pair of wireless earpieces and the electronic device in response to an acceptance of the connection received at an earpiece of the pair of wireless earpieces.

One or more of the following features may be included. The electronic device may be a mobile phone, a tablet, a laptop, or a desktop computer. The camera may be positioned proximate to a side of an earpiece facing away from a user's ear and may face the area directly in front of the user. The camera may capture a video of the area directly in front of the user. The user may be prompted as to whether the electronic device is present in the image. The user may be prompted as to whether the user wishes to establish the connection to the electronic device.

In another embodiment, each earpiece of a pair of wireless earpieces includes an earpiece housing, a processor disposed within the earpiece housing, a motion sensor mounted to the earpiece housing and operatively connected to the processor of the earpiece in which the motion sensor is mounted to, and a transceiver disposed within the earpiece housing and operatively connected to the processor of the earpiece in which the transceiver is disposed within. At least one processor is configured to determine a location of an electronic device using a signal received from the electronic device. Each motion sensor is configured to sense a motion of the wireless earpiece in which the motion sensor is mounted to. Both transceivers are configured to receive the signal from the electronic device, wherein the signal encodes a frequency in which to connect to the electronic device.

One or more of the following features may be included. The pair of wireless earpieces may comprise a left earpiece and a right earpiece. A camera may be mounted to each earpiece housing and may be operatively connected to the processor of the earpiece in which the camera is mounted to, wherein each camera may be positioned proximate to a side of each wireless earpiece facing away from a user's ear and may face an area directly in front of the user. A microphone may be mounted to each earpiece housing and may be operatively connected to the processor of the earpiece in which the microphone is mounted to, wherein each microphone may be configured to receive one or more sounds from the electronic device. At least one processor may be configured to determine a location of the electronic device using the sounds received by each microphone.

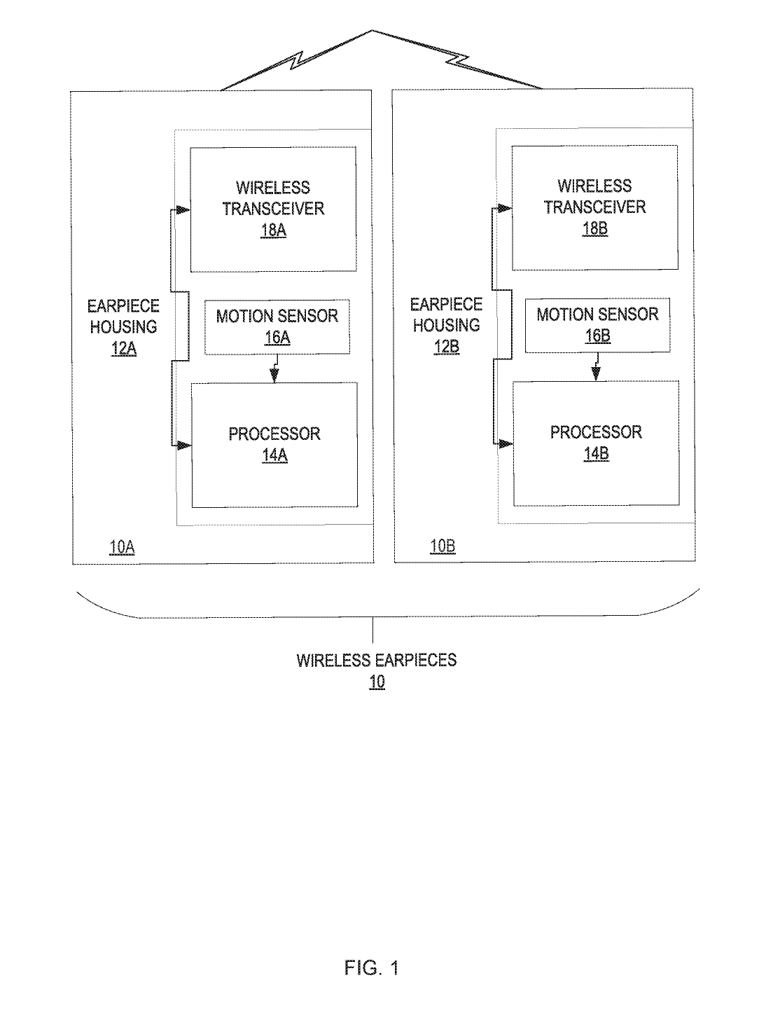

FIG. 1 illustrates a block diagram of a pair of wireless earpieces 10 in accordance with an illustrative embodiment. The pair of wireless earpieces 10A, 10B (or wireless earpiece 10) includes earpiece housings 12A, 12B, processors 14A, 14B disposed within earpiece housings 12A, 12B, motion sensors 16A, 16B mounted to earpiece housings 12A, 12B and operatively connected to processors 14A, 14B, and transceivers 18A, 18B mounted to earpiece housings 12A, 12B and operatively connected to processors 14A, 14B. One or more sleeves may be provided with each wireless earpiece fitted over a portion of each earpiece housing. The sleeves may come in various shapes and sizes and may be used to improve the fit of each wireless earpiece within an ear of the user, improve audio transparency, improve the longevity of a wireless earpiece, protect the user from skin allergies, and so forth.

Earpiece housings 12A, 12B are structurally shaped to fit substantially within the left and right ears of the user. Each earpiece housing 12A, 12B may at least partially enclose one or more of the components of the wireless earpiece 10 and may be composed of one or more plastics, one or more metals, one or more polymers, one or more non-metals, or any material or combination of materials having substantial deformation resistance to facilitate energy transfer if a sudden force is applied to one of the wireless earpieces 10. For example, if one of the wireless earpieces 10 is dropped by the user, the respective earpiece housing 12A, 12B of the wireless earpiece may transfer the energy received from the surface impact throughout the entire wireless earpiece thereby minimizing damage.

In addition, the earpiece housings 12A, 12B may be capable of a degree of flexibility to facilitate energy absorbance if one or more forces is applied to one of the wireless earpieces 10. For example, if an object is dropped on one of the wireless earpieces 10, the earpiece housing of the wireless earpiece 10 may bend to absorb the energy from the impact. The flexibility of the earpiece housings 12A, 12B are not, however, flexible to the point where one or more components of the wireless earpiece 10 may become dislodged or otherwise rendered non-functional due to the force of the impact. Each earpiece housing 12A, 12B may also waterproof enclose components within the wireless earpiece 10.

Processors 14A, 14B are disposed within the earpiece housings 12A, 12B, respectively, and are operatively connected to each of the components of the wireless earpiece 10 in which the processors 14A, 14B are disposed. Each processor 14A, 14B may be a digital integrated circuit, an analog integrated circuit, a mixed integrated circuit, an application-specific integrated circuit, an intelligent control unit, a central processing unit, or another type of component capable of processing data and/or information, and more than one of the types of processors may be integrated together. Processors 14A, 14B may also include logic circuitry, which may include a combinational and/or sequential digital logic, for controlling one or more functions of the wireless earpieces 10. In addition, data and/or instructions may be stored on a register or cache memory integrated with or operatively connected to the processors 14A, 14B for use by the logic circuitry to enhance the functionality of the wireless earpieces 10.

Furthermore, processors 14A, 14B may be programmed to execute one or more kernels, applications, programs, and/or instructions to control the wireless earpieces 10 or process information received from one or more of the components of the wireless earpiece 10. The kernels, applications, programs, and/or instructions used by processors 14A, 14B may be stored in one or more memories operatively connected to the processors 14A, 14B, the registers of the processors 14A, 14B, and/or one or more cache memories associated with the processors. For example, processors 14A, 14B may process a gesture associated with an intent to connect to the user's smartphone. Processors 14A, 14B may subsequently execute instructions to a wireless transceiver (e.g., Bluetooth, Wi-Fi, etc.) to search for one or more signals encoding one or more connection frequencies transmitted by the smartphone. Alternatively, processors 14A, 14B may execute instructions to the wireless transceiver to transmit a signal encoding one or more frequencies in which to connect to one of the wireless earpieces. The signals transmitted by one of the wireless earpieces or the smartphone may be signals transmitted under an 802.11b, 802.11g, or another similar wireless standard. If the other device receives the signal encoding a frequency in which to connect, one of the wireless earpieces and/or smartphone may connect automatically or prompt a party, which may be the user or one or more third parties, whether the party wants to connect.

Motion sensors 16A, 16B are mounted to earpiece housings 12A, 12B and operatively connected to processors 14A, 14B, respectively. Motion sensors 16A, 16B are configured to sense motions relating to each wireless earpiece 10. For example, motion sensors 16A, 16B may be electronic accelerometers, gyroscopes, or so forth, which may be piezoelectric, piezoresistive, or capacitive, and configured to sense an initiation, continuation, or cessation of motion of the wireless earpieces 10 which may be related to an intent to interact or connect to an electronic device. The sensor readings may then be communicated to the processors 12A, 12B associated with the motion sensors 16A, 16B to determine whether the detected motion relates to an associated electronic device. In addition, each processor 14A, 14B may store the readings in a memory operatively connected to the processor 14A, 14B for later use.

Wireless transceivers 18A, 18B are operatively connected to the processors 14A, 14B and disposed within the earpiece housings 12A, 12B. Wireless transceivers 18A, 18B may be Bluetooth transceivers, WiMax transceivers, Wi-Fi transceivers, or another type or class of wireless transceiver simultaneously receiving signals from electronic devices located nearby or at substantial distances. In some examples, the signals or communications may meet one or more IEEE standards.

The wireless transceivers 18A, 18B may be configured to receive signals from mobile devices, such as smartphones, communications towers, satellites, desktops, laptops, desktops, servers, wearable electronics, watches, or other types of electronic devices and communicate the signals to processors 14A, 14B. The processors 14A, 14B may use the data and/or information encoded in the signals during execution of one or more programs or applications and/or store the data and/or information in one or more memories. For example, a signal encoding one or more connection frequencies received from a smartphone or a tablet may be received by each wireless transceiver 18A, 18B and communicated to the processor 14A, 14B associated with each wireless transceiver 18A, 18B.

The wireless transceivers 18A, 18B may receive the signal at different times, positions, orientations, and at different angles, which may be used by one or more of the processors 14A, 14B to determine an origin of the signal. Information encoding the angle and time of signal reception (as well as other information) determined by the one wireless earpiece 10A may be transmitted to the other wireless earpiece 10B via the wireless transceiver or another transceiver, such as a NFMI transceiver. In one example, the origin, position, and orientation may be determined by triangulating the origin from the times and angles of reception using one or more algorithms stored on a memory of either wireless earpiece. Others signal processing methods (e.g., signal strength, beacons, GPS, proximity, etc.) may also be utilized. For example, the algorithms used to triangulate the origin may include instructions employing the law of cosines, the law of sines, or another geometric or trigonometric function.

In one embodiment, once an origin is determined, if the origin is determined to be relatively close to the pair of wireless earpieces 10 and located approximately within a plane between the pair of wireless earpieces 10 when worn by the user, one or both processors 14A, 14B of the pair of wireless earpieces 10 may subsequently instruct the wireless transceivers 18A, 18B associated with the processors 14A, 14B to establish a connection to the smartphone or tablet at the frequency or frequencies encoded in the signal. In another embodiment, the processor 14A may instruct the wireless transceiver 18A to transmit a signal encoding a frequency in which to connect to the wireless earpiece capable of being received by the smartphone or tablet. If the smartphone or tablet receives the signal and attempts to connect to the wireless earpiece 10A, the wireless transceiver 18A of earpiece 10A may communicate the connection signal from the smartphone or tablet to the processor to facilitate connection to the wireless earpiece 10A.

In another embodiment, the wireless earpieces 10 may automatically connect to an electronic device in response to other conditions, criteria, or parameters. In one embodiment, if the electronic device moves with the wireless earpieces 10, the wireless earpieces 10 may automatically connect to (or attempt to connect to) the associated electronic device. In another embodiment, if the electronic device name includes specified keywords, values, or identifiers, the wireless earpieces 10 may automatically connect to the associated electronic device. In another embodiment, the wireless earpieces 10 may utilize historical information to connect to the electronic device. The historical information may include proximity over time, paring or linking history with the wireless earpieces 10, or so forth.

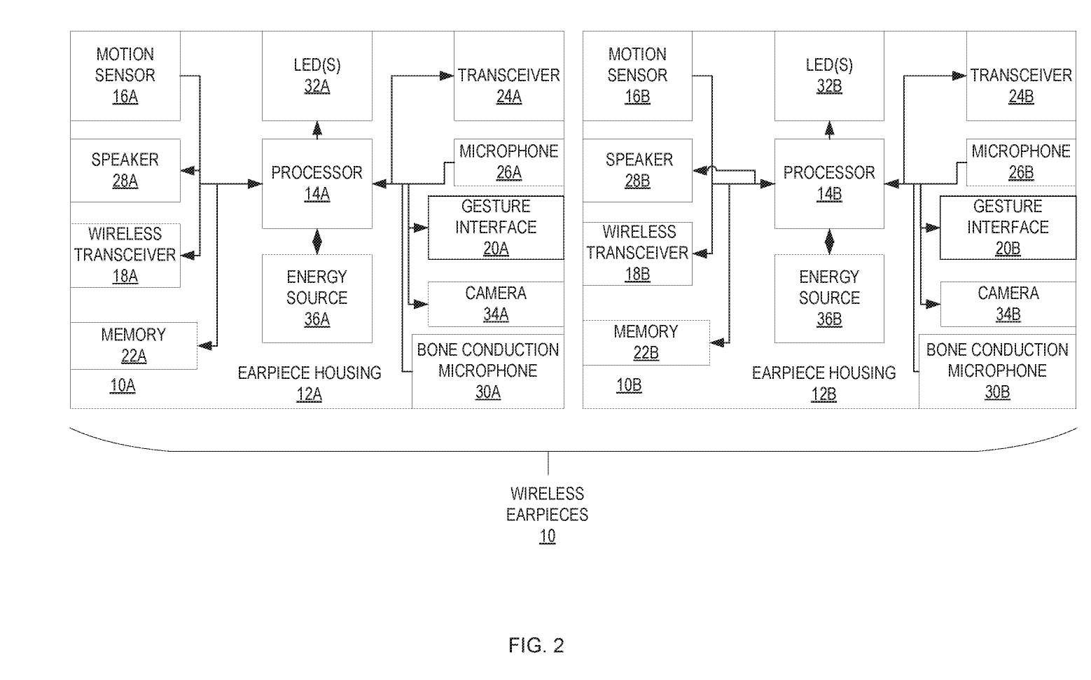

FIG. 2 illustrates a second embodiment of the pair of wireless earpieces 10. In addition to the components listed above, the pair of wireless earpieces 10 may include gesture interfaces 20A, 20B, memories 22A, 22B, transceivers 24A, 24B, microphones 26A, 26B, speakers 28A, 28B, bone conduction microphones 30A, 30B, light emitting diodes (LEDs) 32A, 32B, cameras 34A, 34B, and energy sources 36A, 36B. Although shown, the components are interconnected utilizing any number of wires, busses, traces, pens, contacts, interfaces, or so forth.

The gesture interfaces 20A, 20B may be operatively connected to the processors 14A, 14B and may be mounted to or integrated within earpiece housings 12A, 12B. The gesture interfaces 20A, 20B may be configured to allow a user to control one or more programs or functions of the wireless earpiece 10. Gesture interfaces 20A, 20B may each include at least one emitter and at least one detector to detect gestures, contact, user input, or other feedback received from either the user, a third-party, an instrument, or a combination. The signals representing one or more gestures detected by the gesture interfaces 20A, 20B may be communicated to the processors 14A, 14B for utilization. The gestures used with the gesture interfaces 20A, 20B to control the wireless earpiece 10 include, without limitation, touching, tapping, swiping, proximate motions, use of an instrument, or any combination of the gestures. Touching gestures used to control the wireless earpiece 10 may be of any duration and may include the touching of areas not part of a gesture interface. Tapping gestures used to control the wireless earpiece 10 may include any number of taps and need not be brief. Swiping gestures used to control the wireless earpiece 10 may include a single swipe, a swipe changing direction at least once, a swipe with a time delay, a plurality of swipes, or any combination. An instrument used to control the wireless earpiece 10 may be electronic, biochemical or mechanical, and may interface with a gesture interface either physically or electromagnetically.

The memories 22A, 22B may be operatively connected to the processors 14A, 14B and may be disposed within, mounted to, or integrated with the earpiece housings 12A, 12B. The memories 22A, 22B may be any type of non-volatile memory, which may be static and/or dynamic, allowing data storage when an earpiece is not powered. In some preferred embodiments additional volatile memories such as random-access memories may be incorporated into memories 22A, 22B to allow for improved functionality. The memories 22A, 22B may be configured and/or programmed to store kernels, applications, programs, instructions and/or data for either concurrent or future use and in some embodiments the memories 22A, 22B may be integrated with processors 14A, 14B for improved functionality. The kernels, applications, programs, instructions and/or data stored on the memories may relate to algorithms to determine an origin of an electronic device from one or more inputs or algorithms to determine one or more user gestures. The memories 22A, 22B may also store songs, podcasts, or other forms of media for which the user may listen to.

The transceivers 24A, 24B may be operatively connected to the processors 14A, 14B and may be disposed within, mounted to, or integrated within the earpiece housings 12A, 12B. The transceivers 24A, 24B may be near field magnetic induction (NFMI) transceivers, Bluetooth transceivers, WiMax transceivers, Wi-Fi transceivers, hybrid transceivers (e.g., NFMI and Bluetooth), or another type, combination, or class of transceiver meeting one or more IEEE standard. As noted, more than one type of transceiver, such as a hybrid or multi-mode transceiver, may be located within the wireless earpiece 10.

The transceivers 24A, 24B may be configured to transmit signals to or receive signals from the other wireless earpiece 10 of the pair of wireless earpieces 10. For example, the transceiver 24A may transmit a signal encoding information related to the reception of a signal or sound at the wireless earpiece 10A to transceiver 24B so processor 14B may use the information encoded in the signal to determine an origin of the signal, sound, or electronic device. Transceivers 24A, 24B may also be capable of receiving signals from mobile devices, communications towers, Wi-Fi hotspots, or other communication locations. For example, signals received by a user's mobile device 60 (e.g., 3G, 4G, 5G, PCS, LTE, etc.) encoding programs for use by the pair of wireless earpieces 10 may be transmitted by the mobile device 60 to one of the transceivers for concurrent or future use.

Microphones 26A, 26B may be operatively connected to processors 14A, 14B and may be mounted to or integrated with earpiece housings 12A, 12B. Microphones 26A, 26B may include components such as analog-to-digital converters, amplifiers, attenuators, filters, and/or other components necessary for each microphone 26A, 26B to convert a sound wave into an electrical signal. In one embodiment, the microphones 26A, 26B may be positioned on a section of the earpiece housing 12A, 12B facing away from the user's ear to receive a voice command or a sound from an electronic device. The sounds from the electronic device may be used to determine if the electronic device is relatively close to the user. For example, microphone 26A may receive a sound at a certain intensity and angle and microphone 26B may receive the same sound at a different intensity and angle. Information related to the sounds may be shared via one or more signals transmitted by wireless transceivers 20A, 20B or transceivers 24A, 24B. The processors 14A, 14B may then use one or more applications or algorithms to ascertain an origin of the sound. In addition, voice commands and sounds received by microphones 26A, 26B may be stored in memories 22A, 22B for future use.

Speakers 28A, 28B may be operatively connected to the processors 14A, 14B and may be mounted to or integrated with the earpiece housings 12A, 12B. The speakers 28A, 28B may be positioned in an area conducive for communicating sounds to the tympanic membrane of the user's ear and may include components, such as bass speakers, mid-range speakers, tweeters speakers, digital-to-analog converters, amplifiers, attenuators, filters, and/or other components necessary for speakers 28A, 28B to convert an electrical signal into a sound wave. The components of speakers 28A, 28B may be further configured and/or programmed to generate three-dimensional stereo sound or to generate sounds at specific frequencies. Speakers 28A, 28B may also be configured to prompt the user in response to one or more commands from the processors 14A, 14B whether the user wishes to connect to an electronic device if the one or more processors determine a cessation of movement or a user gesture infers an intent to connect to the electronic device.

Bone conduction microphones 30A, 30B (e.g., ear bone microphones) may be operatively connected to the processors 14A, 14B and may be mounted to or integrated within the earpiece housings 12A, 12B to meet a temporal bone/skull of the user when the earpieces are inserted into the user's ear canals. The bone conduction microphones 30A, 30B may be configured to communicate sounds and/or vibrations via the temporal bone for user's who have difficulty hearing. In addition, the bone conduction microphones 30A, 30B may be configured to help filter out sounds to differentiate between sounds originating from the user and sounds originating from a third party or another external location.

The LEDs 32A, 32B may be operatively connected to the processors 14A, 14B and may be mounted to or integrated within the earpiece housings 12A, 12B. The LEDs 32A, 32B may be semiconductor-based light sources and may include displays, touch sensors, and/or other interactive interface components. In addition, the LEDs 32A, 32B may be configured to provide information concerning the wireless earpieces 10. For example, the processors 14A, 14B may communicate a signal encoding information related to the current time, the energy level of a wireless earpiece, the status of another operation of the wireless earpiece, or another earpiece program or function to the LEDs 32A, 32B. If the signal concerns the energy level of the wireless earpieces 10, the LEDs 32A, 32B may decode the signal as a colored light. For example, a blue light may represent a full battery, a green light may represent a high level of battery life, a yellow light may represent an intermediate level of battery life, a red light may represent a limited amount of battery life, and a blinking red light may represent a critical level of battery life requiring immediate recharging. In addition, the battery life may be represented by the LEDs 32A, 32B as a percentage of battery life remaining or may be represented by an energy bar having one or more LEDs. The number of illuminated LEDs represents the amount of battery life remaining in the wireless earpieces 10.

The LEDs 32A, 32B may be in any area on the wireless earpieces 10 suitable for viewing by the user or a third party and may also include as few as one diode which may be provided in combination with a light guide. In addition, the LEDs 32A, 32B need not have a minimum luminescence.

The cameras 34A, 34B may be operatively connected to the processors 14A, 14B and may be mounted to or integrated within the earpiece housings 12A, 12B. The cameras 34A, 34B may be positioned at any location allowing the cameras 34A, 34B to capture images or video of an electronic device directly in front of the user (or otherwise positioned). The images or video may be stored within the memories 22A, 22B. In one embodiment, images captured by cameras 34A, 34B may be stored in raster formats, such as JPEG, TIFF, GIF, BMP, or PNG, vector formats, such as AI or EPS, compound formats, such as EPS, PDF, SWF, or PostScript, or other suitable formats.

Videos recorded by the cameras 34A, 34B may be stored in formats, such as AVI, WMV, MOV, MP4, FLV, or other similar formats. The formats may include any number of video coding and audio coding formats as well. The cameras 34A, 34B may capture images or video automatically when one of the wireless earpieces 10 ceases motion or when the user performs a gesture reasonably interpreted to infer an intent to interact with an object in front of the user. Such motions may also be captured by the motion sensors 16A, 16B. In addition, the cameras 34A, 34B may capture images or video in response to a command from the user or a third party. The commands used to control the camera 16A, 16B may be voice commands received by microphones 26A, 26B, gestures received by gesture interfaces 20A, 20B, or instructions encoded in signals issued via a smartphone or another external electronic device.

Energy sources 36A, 36B may be operatively connected to all the components within their respective wireless earpieces 10 and may provide enough power to operate their respective wireless earpieces 10 for a reasonable duration of time. Energy sources 36A, 36B may be of any type suitable for powering their respective wireless earpieces 10, such as Lithium ion batteries, solar cells, piezo electric generators, fuel cells, kinetic motion generators, thermal generators, and so forth. The energy sources 36A, 36B may be internally integrated or externally connected. Alternative battery-less power sources, such as sensors configured to receive energy from radio waves (all of which are operatively connected to one or more wireless earpieces 10) may be used to power the wireless earpieces 10 in lieu of an energy source 36A, 36B.

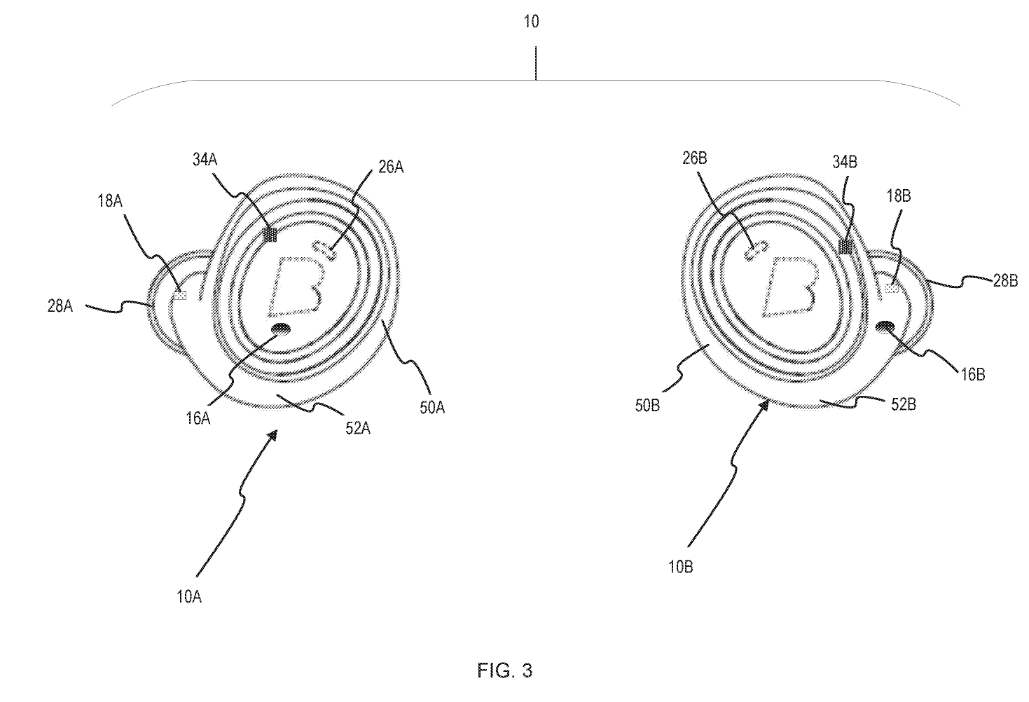

FIG. 3 illustrates the pair of wireless earpieces 10 which includes a left wireless earpiece 50A and a right wireless earpiece 50B. The left wireless earpiece 50A has a left wireless earpiece housing 52A. The right wireless earpiece 50B has a right wireless earpiece housing 52B. The left wireless earpiece 50A and the right wireless earpiece 50B may be configured to fit on, at, or within a user's external auditory canal and may be configured to substantially minimize or eliminate external sound capable of reaching the user's tympanic membranes. The earpiece housings 52A, 52B may be composed of any material with substantial deformation resistance and may also be configured to be soundproof or waterproof.

The motion sensors 16A and 16B are shown. The motion sensors 16A, 16B may be configured to sense a cessation of motion in the wireless earpieces 10 and may also be configured to sense one or more motions representing a gesture, such as a nod or a shaking of a user's head. The wireless transceivers 18A and 18B are also shown. Each wireless transceiver 18, 18B may be configured to receive signals from other electronic devices or may transmit one or more connection signals received by other devices. The signals received from other electronic devices may encode frequencies and/or wavelengths in which to establish a connection to the electronic device. The connection signals transmitted by wireless transceivers 18A, 18B may encode one or more frequencies and/or wavelengths in which the left wireless earpiece 50A, the right wireless earpiece 50B, and/or one or more electronic devices may communicate with each other. The signals received by the wireless transceivers 18A, 18B may be communicated to the processors 14A, 14B (see also FIGS. 1-2) so an origin of the signal or signals may be determined utilizing associated information (e.g., directional signal data, signal strength/amplitude, phase, phase offset, time differential between wireless earpieces, triangulation, beacon information, etc.).

The microphones 26A, 26B are also shown. The microphones 26A, 26B may be located anywhere on the left wireless earpiece 50A and the right wireless earpiece 50B, respectively, and each microphone 26A, 26B may be positioned to receive one or more sounds or voice commands from the user or receive one or more sounds from an electronic device which may be used to determine an origin of an electronic device. If the sounds are not voice commands, the angles, times, and/or intensities of the sounds may be communicated to the processors to determine an origin of the sound. If the sound originates from an electronic device and it is determined the electronic device is nearby, the processors 14A, 14B may instruct the wireless transceivers 18A, 18B to sense whether the electronic device in the vicinity is communicating signals encoding a connection frequency. If so, the processors 14A, 14B may connect to the electronic device at the connection frequency encoded in the signal. A speaker 28A is shown on the left earpiece 50A and a speaker 28B is shown on the right earpiece 50B. Speakers 28A and 28B may be positioned proximate to the user's tympanic membranes and may also be configured to communicate inquiries as to whether the user wishes to connect to a nearby electronic device such as a smartphone or a tablet.

The cameras 34A, 34B are shown. In one embodiment, the cameras 34A, 34B may be positioned proximate to a side of each wireless earpiece 10 facing away from a user's ear and facing an area directly in front of the user. The cameras 34A, 34B may be configured to capture images or video of the area directly in front of the user and communicate the images to the processors 14A, 14B for processing (see FIGS. 1-2). The view of the cameras 34A, 34B may vary based on the configured direction of the cameras 34A, 34B as well as the user-specified application. In one embodiment, the images or videos may be used by the processors 14A, 14B to determine if an electronic device is directly in front of the user. If this is the case, the processors 14A, 14B may instruct the wireless transceivers 18A and/or 18B to transmit a signal encoding one or more connection frequencies near the electronic device.

In another embodiment, the processors 14A, 14B may attempt to search for signals encoding one or more connection frequencies currently being transmitted and attempt to determine whether one of those signals originates from the electronic device proximate the user. If one of the signals does originate from the electronic device in an image or video captured by the camera, one or both processors 14A, 14B may automatically connect to the electronic device or may prompt the user to indicate whether the user wishes to connect to the electronic device.

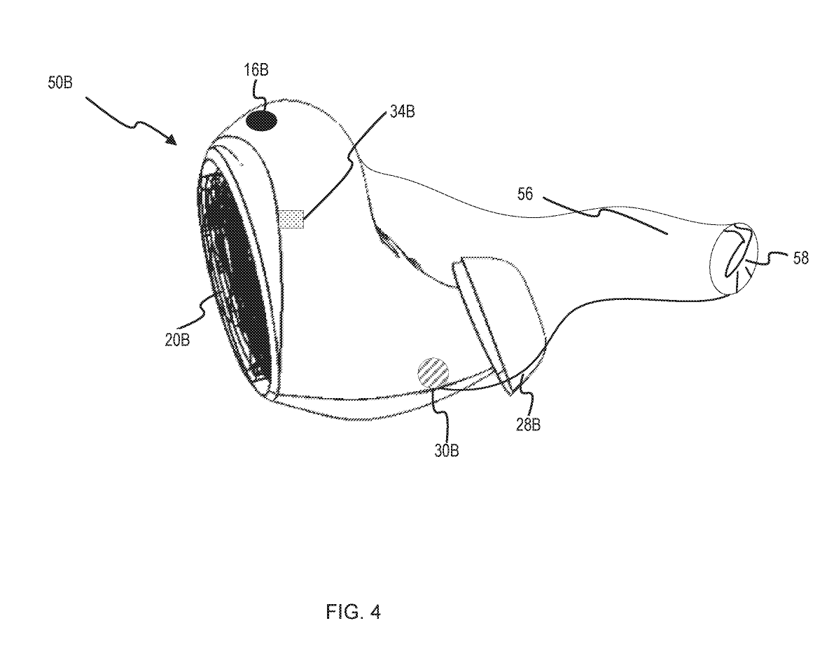

FIG. 4 illustrates a side view of the right wireless earpiece 50B and its relationship to a user's ear. The right wireless earpiece 50B may be configured to both minimize the amount of external sound reaching the user's external auditory canal 56 and to facilitate the transmission of sound from the speaker 28B to a user's tympanic membrane 58. The right wireless earpiece 50B may also be configured to be of any size necessary to comfortably fit within the user's external auditory canal 56. A motion sensor 16B, which may include an electronic accelerometer, may be positioned on the right wireless earpiece 50B to sense changes in the motion of the right wireless earpiece 50B and convey cessations of motion to processor 14B.

In addition, a bone conduction microphone 30B may be positioned near the temporal bone of the user's skull to receive sound vibrations from people who have difficulty speaking loudly. The bone conduction microphone 30B may also sense sounds before the sounds reach the microphones 26B (see FIG. 3) to differentiate between sounds from the user and ambient sounds.

The gesture interface 20B may provide for gesture control by the user or a third party, such as by tapping or swiping across the gesture interface 20B, tapping or swiping across another portion of the right wireless earpiece 50B, providing a gesture not involving the touching of the gesture interface 20B or another part of the right wireless earpiece 50B, or using an instrument configured to interact with the gesture interface 20B. The user may use the gesture interface 20B to pair or connect one or more electronic devices which are close to the user and/or proximate the pair of wireless earpieces 10. The camera 34B may be positioned in an area of the right wireless earpiece 50B to capture an image or a video of an area in front of the user.

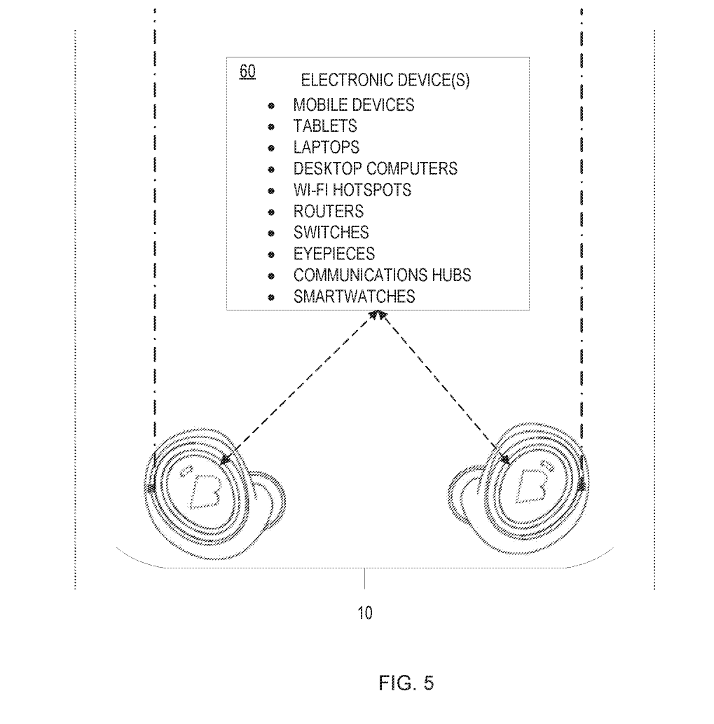

FIG. 5 illustrates a pair of wireless earpieces 10 and their relationship to an electronic device 60. The electronic device 60 may be a smartphone, a tablet, a laptop, a desktop computer, a smartwatch, an eyepiece, smart clothing, smart jewelry, a headset, a router, a switch, a communications hub, a Wi-Fi hotspot or connection point, or another type of consumer electronic device capable of wirelessly linking with the wireless earpieces 60 without limitation.

The electronic device 60 may be located at any distance from the wireless earpieces 10. For example, common distances may vary from between 1-40 meters. Additionally, the electronic device 60 may be located at a greater distance. For example, a Wi-Fi hub located across a room or even a billboard capable of transmitting a signal may be at the far extreme of the transceivers range. The electronic device 60 may be approximately within a horizontal plane or bubble associated with the wireless earpieces 10 when worn by a user so it can potentially be inferred the user may wish to interact with something directly in front of him or her.

The wireless earpieces 10 may infer a connection is desired utilizing any number of factors, conditions, settings, user preferences, or so forth. In one embodiment, a plane associated with the wireless earpieces 10 is utilized at any number of distance thresholds (e.g., 2 meters, 10 feet, 20 meters, etc.) to automatically connect to the electronic device 60. In another embodiment, location of the electronic device 60 in proximity to the user in addition to user input (e.g., a head nod, finger tap, hand/finger gesture, verbal command, or combination thereof) may be utilized to connect to the electronic device 60. In addition to proximity information, motion toward the electronic device 60 by the wireless earpieces 10/user may also be utilized. In another embodiment, user location as well as the orientation of the wireless earpieces may be utilized to determine the user wants to connect to the electronic device. For example, if the wireless earpieces 10 indicate the user is looking at the electronic device for at least three seconds followed by a user input (e.g., head nod, tap, or verbal command) the wireless earpieces 10 may automatically connect or attempt to connect to the electronic device 60. The wireless earpieces 10 may also utilize historical information associated with the electronic device 10 in addition to proximity, motion, location, and orientation to determine whether to connect. The historical information may include whether the wireless earpieces 10 and the electronic device 60 have been previously paired or connected, user/device identifiers (e.g., name, associated user, identifiers, common IP addresses, etc.), or so forth.

Any number of prompts, alerts, or indicators may also be utilized to determine whether the user desires or authorizes a connection or communication between the wireless earpieces 10 and the electronic device 60. For example, the user preferences may require an alert indicator (e.g., audio, tactile, visual) even if the criteria for automatically connecting to the wireless earpieces 10 are met.

The electronic device 60 may be located outside the horizontal plane created by the pair of wireless earpieces 10 so long as it may be inferred the user of the pair of wireless earpieces 10 wishes to interact with the electronic device 60. The origin of the signal transmitted or generated by the electronic device 60 may also be located within the horizontal plane. Like the location of the electronic device 60, the origin of the signal may be located outside the horizontal plane created by the pair of wireless earpieces 10 so long as it can be potentially inferred the user of the pair of wireless earpieces 10 wishes to interact with an object in front of him or her may be potentially associated with the signal.

In some embodiments, the origin of a signal transmitted or generated by the electronic device 60 may not be located within a horizontal plane extending between the wireless earpieces 10, such as a desktop computer where the user is viewing the monitor, but the tower, hard drive, transceiver, processor, and other components are located at some distance from the monitor or a router located away from the line of sight of the monitor. In one example, where the origin of a signal is only a few meters away but is outside a horizontal plane extending from the pair of wireless earpieces 10, then the processors of one of the wireless earpieces may instruct a speaker to prompt the user if the user wishes to connect to the electronic device 60 generating the signal. The user may respond verbally to the prompt as to whether to connect to the electronic device 60 with a yes or no answer, nod or shake his or her head (e.g., a nod is yes, and a shake is no), perform a gesture on a gesture interface to provide an affirmative or dissenting action, provide a non-responsive answer, inquire as to the identity of the electronic device 60, or ignore the question. If the user answers in the affirmative, then the wireless earpieces 10 connects to the electronic device 60 which transmitted the signal. If the user answers in the negative, then no connection is made. If the answer provided by the user is non-responsive or no answer is provided, then the wireless earpieces 10 may continue to prompt the user a few more times before concluding the user does not wish to connect to the electronic device 60 generating or transmitting the signal. If the user inquires as to the identity of the electronic device 60, then the wireless earpieces 10 may provide the identifying information if it was provided in the signal, inform the user no identifying information is provided, or prompt the user as to the potential identity of the electronic device 60. The user may or may not provide the identity of the electronic device 60 if prompted for the information. After the wireless earpieces 10 provide the identification of the electronic device 60 or after a response provided by the user, the wireless earpieces 10 may prompt the user again as to whether the user wishes to connect to the electronic device 60. The user may respond as provided above.

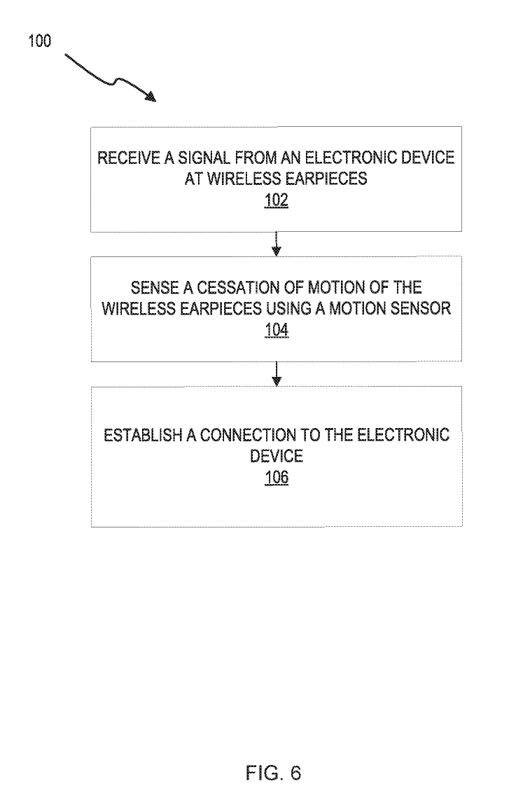

FIG. 6 illustrates a flowchart 100 of a method of connecting to an electronic device using a pair of wireless earpieces. The electronic device may be a smartphone, a tablet, a laptop, a desktop computer, a smartwatch, an eyepiece, a headset, a router, a switch, a communications hub, a Wi-Fi hotspot or connection point, or another type of electronic device capable of wirelessly linking with a wireless earpiece without limitation.

First, in step 102, the wireless earpieces receive a signal from the electronic device. The signal may be received continuously or intermittently. The signal may be an electromagnetic signal communicated by an electronic device and received by a wireless transceiver or one or more sounds generated by an electronic device and received by a microphone or bone conduction microphone. If the signal is a sound, the sound may derive from one or more pieces of media being played on the electronic device or one or more mechanical, electrical, or electromechanical sounds generated by the electronic device. The signal may be received at one wireless earpiece before the other wireless earpiece, and the angle of reception of the signal may also differ between the wireless earpieces as well.

In step 104, a motion sensor senses a cessation of motion of the wireless earpieces. The cessation of motion may be momentary or may last for more than a few seconds. Only one wireless earpiece needs to sense a cessation of motion. If only one wireless earpiece senses a cessation of motion, then the wireless earpiece may transmit a signal via a wireless transceiver or another transceiver encoding the cessation of motion to the other wireless earpiece. Alternatively, a motion sensor of one of the wireless earpieces may sense a unique motion used to infer an intent of the user to interact with an object. If so, then the process proceeds to step 106 like normal.

In step 106, a connection is established to the electronic device. In one embodiment, the connection is established in response to the cessation of motion if it is determined the signal from the electronic device both originates within a few meters of the wireless earpieces and approximately within a horizontal plane between the pair of wireless earpieces. The origin of the signal may be determined by executing one or more programs or applications stored in a memory or the processor of the wireless earpieces using the times of reception of the signal at each earpiece, determined position and orientation information, signal amplitude, global positioning information, beacon information, the angles of reception of the signal at each wireless earpiece and, if the signal is a sound, the intensities of the sound at each wireless earpiece. The programs or applications used to determine the origin of the signal may include algorithms related to the law of cosines, the law of sines, or other trigonometric or geometric functions. Processors within each wireless earpiece may instruct transceivers to transmit signals encoding signal information related to the processor's earpiece to the other wireless earpiece for use in determining the signal origin. If the origin is determined to be no more than a few meters away from the user and the origin lies approximately within a horizontal plane between the wireless earpieces, then the connection may be established by communicating a signal at one or more frequencies encoded in the signal transmitted by the electronic device or one or both of the wireless earpieces may transmit a signal encoding one or more connection frequencies capable of being received by an electronic device within a few meters of the user. The electronic device may subsequently connect if the signal is received.

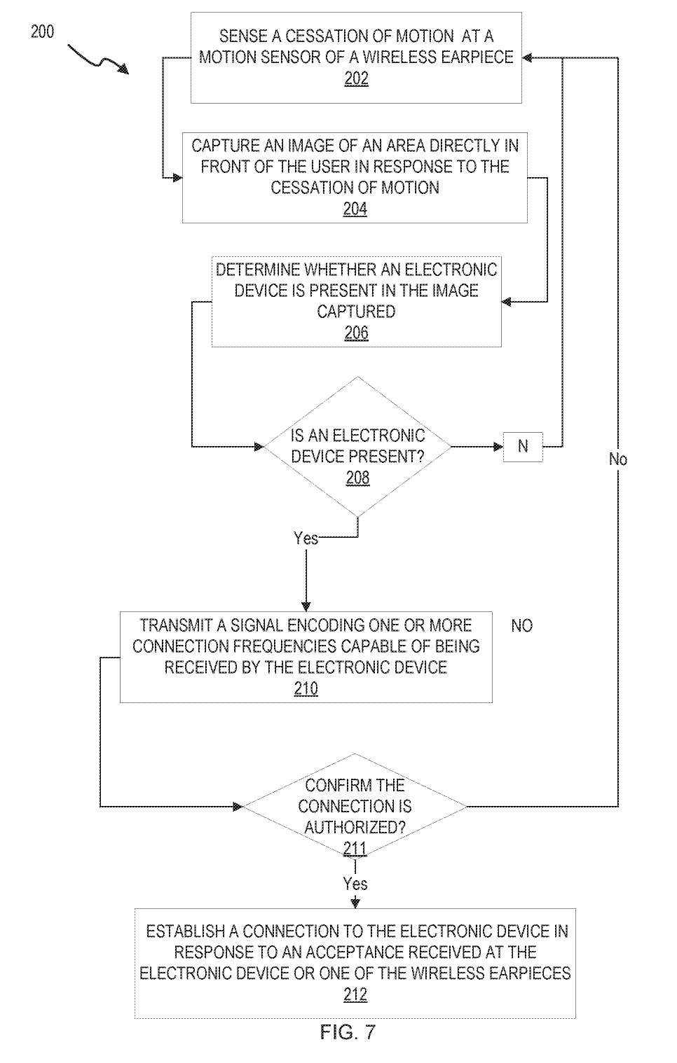

FIG. 7 illustrates a flowchart 200 of a second embodiment of a method for connecting to an electronic device using a pair of wireless earpieces. First, in step 202, a motion sensor senses a cessation of motion of a wireless earpiece. The cessation of motion may be momentary or may last for more than a few seconds. Only one wireless earpiece needs to sense a cessation of motion. If only one wireless earpiece senses a cessation of motion, then the wireless earpiece may transmit a signal via a wireless transceiver or another transceiver encoding the cessation of motion to the other wireless earpiece. In another embodiment, a motion sensor of one of the wireless earpieces may sense a unique motion used to infer a possible intent of a user to interact with an object. If so, then the process proceeds to step 204 as normal. In another embodiment, the wireless earpieces may utilize location, velocity/heading, orientation, history, or so forth as previously noted.

In step 204, a camera operatively connected to the wireless earpiece captures an image of an area. In one embodiment, the image may be directly in front of the user. The image may be captured in response to the cessation of motion (or a motion which may reasonably represent an intent to interact with an object directly in front of the user). The camera may also record a video of the area directly in front of the user. The camera may be positioned proximate to a side of the wireless earpiece facing away from the user's ear and facing the area in front of the user to capture images or video directly in front of the user. More than one image or video may be captured, and each image and/or video may be stored in a memory for later use or to expedite connection to an electronic device. Only one camera need capture an image or video. If this is the case, then information related to the image or video may be encoded in a signal and transmitted to the other wireless earpiece for later use.

In step 206, at least one of the processors present in the pair of wireless earpieces determines whether an electronic device is present in an image or video captured. Information related to an image or video captured by a camera may be encoded in a signal and transmitted via a transceiver to the other earpiece if necessary. Whether an electronic device is present in an image or video may be determined via the execution of one or more programs or applications stored on a memory by a processor. The programs or applications used to determine whether an image or video is related to an electronic device may include image/device recognition programs and algorithms capable of comparing pixel sequences of electronic device images stored in a memory of an earpiece to an image or video captured by a camera. An exact match is not required; any sequence of pixels having a non-negligible chance of being associated with an electronic device may be acceptable. Whether the electronic device in an image or video is nearby may be inferred from the percentage of the image or video devoted to the electronic device and/or the light intensities present in the images or videos. The wireless earpieces may utilize a database/library of default images to make comparisons and perform determinations.

In step 208, the wireless earpieces may determine whether an electronic device is present. The determination may be performed automatically or based on feedback from the user. For example, the wireless earpieces may identify the electronic device from captured image/video content. Frequency scanning, pairing information, or other details may also be utilized. In another example, the processor may instruct a speaker to communicate a question as to whether an electronic device is present in front of the user. The user may respond verbally with a yes or no answer, nod or shake his or her head (e.g., where a nod is a yes and a shake is a no), perform a gesture on a gesture interface to provide an affirmative or dissenting action, provide a non-responsive answer, or ignore the question. If the user answers in the negative, then the process ceases or returns to step 202. If the user answers in the affirmative, ignores the question or provides a non-responsive answer to the question, then the process proceeds to step 208.

In step 208, if a potential match for an electronic device is found, then in step 210 a processor of one of the earpieces transmits a signal encoding one or more connection frequencies capable of being received by the electronic device. The other wireless earpiece may also transmit the same signal. In one example, the strength of the signal may only have a radius of a few meters. In other embodiments, the radius may extend tens or hundreds of meters. In step 211, the processor of one of the wireless earpieces may instruct a speaker to communicate a question to confirm the user authorizes the connection with the electronic device (e.g., identified by an image captured by the wireless earpieces). The user may respond verbally with a yes or no answer, nod or shake his or her head (e.g., where a nod is yes, and a shake is no), perform a gesture on a gesture interface to provide an affirmative or dissenting action, provide a non-responsive answer, or ignore the question. If the user responds in the negative, then the process ceases or returns to step 202. If the user responds in the affirmative, provides a non-responsive answer, or ignores the question, then the process proceeds to step 212. If the user provides a non-responsive answer or ignores the question, the question may be repeated a few additional times until answered affirmatively or negatively. If the user answers in the negative, however, then the process ceases or returns to step 202.

In step 212, a connection is established if the electronic device or one of the wireless earpieces accepts a connection request. The connection may be established instantaneously with the acceptance of the connection or the connection may be established at a time after acceptance of the connection. If the other wireless earpiece transmitted a connection signal, the acceptance of the connection with the wireless earpiece may happen at a different time than the acceptance of the connection with the other earpiece. In addition, it is possible the electronic device only establishes a connection with one wireless earpiece. Acceptance of the connection may occur (1) in accordance with one or more programs or applications present in one or more of the earpieces, (2) as a result of one or more actions taken by the user or one or more third parties related to the pair of wireless earpieces, (3) in accordance with one or more programs or applications present on the electronic device, (4) as a result of user preferences, parameters, settings, or criteria (illustrative examples of which are noted herein) and/or (5) as a result of one or more actions taken by one or more third parties related to the electronic device. The connection may be terminated by the user or one or more third parties at either one of the wireless earpieces or the electronic device at any time.

The illustrative embodiments are not to be limited to the embodiments and examples described herein. The illustrative embodiments contemplate numerous variations in the type of ways in which the embodiments may be applied. The foregoing description has been presented for purposes of illustration and description. It is not intended to be an exhaustive list or limit any of the disclosure to the precise forms disclosed. It is contemplated other alternatives or exemplary aspects are considered included in the disclosure. The description is merely examples of embodiments, processes or methods of the invention. It is understood any other modifications, substitutions, and/or additions may be made, which are within the intended spirit and scope of the disclosure. For the foregoing, the disclosure accomplishes at least all the intended objectives.

What is claimed is:

1. A method of connecting to an electronic device using a pair of wireless earpieces comprising:
receiving a signal from the electronic device at each earpiece of the pair of wireless earpieces;
sensing a cessation of motion from an earpiece of the pair of wireless earpieces; and
connecting at least one earpiece of the pair of wireless earpieces to the electronic device in response to the cessation of motion if the signal from the electronic device originates (1) within three meters from a user, and (2) approximately within a horizontal plane between the pair of wireless earpieces.

2. The method of claim 1, wherein the electronic device is a mobile phone, a tablet, a laptop, or a desktop computer.

3. The method of claim 1, wherein the signal is a sound wave.

4. The method of claim 1, wherein the signal is received continuously.

5. The method of claim 1, wherein the signal encodes at least one frequency in which to communicate with the electronic device.

6. The method of claim 1, further comprising: recording positions of a user's head at each earpiece while receiving the signal from the electronic device at each earpiece of the pair of wireless earpieces.

7. The method of claim 6, further comprising determining an intent of the user using the positions of a head of the user determined by the pair of wireless earpieces.

8. The method of claim 7, further comprising connecting at least one wireless earpiece of the pair of wireless earpieces to the electronic device in response to a determination of the intent of the user if the intent of the user is to interact with the electronic device and the signal from the electronic device originates (1) within three meters from the user and (2) approximately within a horizontal plane created by the positions of the head of the user at each earpiece while receiving the signal from the electronic device at each earpiece of the set of wireless earpieces.

9. The method of claim 1, further comprising: prompting the user to connect to the electronic device if the signal from the electronic device originates (1) within three of the user and (2) approximately within a horizontal plane between the pair of wireless earpieces.

10. A method of connecting to an electronic device using a pair of wireless earpieces comprising:
sensing a cessation of motion at an earpiece of the pair of wireless earpieces;
capturing an image of an area directly in front of a user in response to the cessation of motion;
determining whether the electronic device is present in the image;
transmitting a connection signal capable of being received by the electronic device if the electronic device is present in the image; and
establishing a connection between the pair of wireless earpieces and the electronic device in response to an acceptance of the connection received at an earpiece of the pair of wireless earpieces.

11. The method of claim 10, wherein the electronic device is a mobile phone, a tablet, a laptop, or a desktop computer.

12. The method of claim 10, wherein the camera is positioned proximate to a side of an earpiece facing away from a user's ear and facing the area directly in front of the user.

13. The method of claim 10, wherein the camera captures a video of the area directly in front of the user.

14. The method of claim 10, further comprising prompting the user whether the electronic device is present in the image.

15. The method of claim 10, further comprising prompting the user whether the user wishes to establish the connection to the electronic device.

16. A pair of wireless earpieces, each wireless earpiece comprising:
an earpiece housing;
a processor disposed within the earpiece housing;
a motion sensor mounted to the earpiece housing and operatively connected to the processor of the earpiece in which the motion sensor is mounted to; and
a transceiver disposed within the earpiece housing and operatively connected to the processor of the earpiece in which the transceiver is disposed within;
wherein at least one processor is configured to determine a location of an electronic device using a signal received from the electronic device;
wherein each motion sensor is configured to sense a motion of the wireless earpiece in which the motion sensor is mounted to; and
wherein both transceivers are configured to receive the signal from the electronic device, wherein the signal encodes a frequency in which to connect to the electronic device.

17. The pair of wireless earpieces of claim 16, wherein the pair of wireless earpieces comprises a left earpiece and a right earpiece.

18. The pair of wireless earpieces of claim 16, further comprising: a camera mounted to each earpiece housing and operatively connected to the processor of the earpiece in which the camera is mounted to, wherein each camera is positioned proximate to a side of each wireless earpiece facing away from a user's ear and facing an area directly in front of the user.

19. The pair of wireless earpieces of claim 16, further comprising: a microphone mounted to each earpiece housing and operatively connected to the processor of the earpiece in which the microphone is mounted to, wherein each microphone is configured to receive one or more sounds from the electronic device.

20. The pair of wireless earpieces of claim 19, wherein at least one processor is configured to determine a location of the electronic device using the sounds received by each microphone.
